(19) United States
(12) Patent Application Publication
(10) Pub. No.: US 2025/0267327 A1
(43) Pub. Date: Aug. 21, 2025

(54) MEDIA PLAYBACK DEVICE AND MEDIA PLAYBACK METHOD

(71) Applicant: Realtek Semiconductor Corp., HsinChu (TW)

(72) Inventor: Chun-Yi Chen, HsinChu (TW)

(73) Assignee: Realtek Semiconductor Corp., HsinChu (TW)

(21) Appl. No.: 19/046,528

(22) Filed: Feb. 6, 2025

(30) Foreign Application Priority Data
Feb. 15, 2024 (TW) 113105193

(51) Int. Cl. H04N 21/43; H04N 21/8547

(52) U.S. Cl. CPC H04N 21/43072; H04N 21/8547

(57) ABSTRACT

A media playback method includes: establishing one or more playback processing modules respectively corresponding to one or more media sources; utilizing an audio and video control sub-module of at least one playback processing module in the one or more playback processing modules to provide and update timing information; and controlling timing synchronization of the at least one playback processing module when processing a plurality of audio data units and a plurality of video data units according to the timing information.

### BACKGROUND OF THE INVENTION

### 1. Field of the Invention

The present invention relates to media playback, and more particularly, to a media playback device and related media playback method with independent audio-to-video synchronization control architecture.

### 2. Description of the Prior Art

With the advancement and diversification of signal transmission technologies, there are more and more ways to obtain audiovisual contents. For example, digital video broadcasting (DVB) services, Internet protocol television (IPTV) services, and satellite television services all offer a wide range of channels, programs, or audiovisual contents. However, media playback devices often cannot respond immediately to user playback operations when playing audiovisual contents provided by these services. One significant reason is the delay caused by audio-to-video synchronization operations. During general playback, the media playback device must perform synchronization control on video content and audio content to ensure their temporal alignment in presentation, achieving the audio-to-video synchronization. Such operation usually requires a certain amount of time, thus leading to response delays in the media playback device when the user switches channels, programs, or audiovisual contents. In view of this, there is a need in the art for architecture that can be applied in the media playback device to effectively control the audio-to-video synchronization.

### SUMMARY OF THE INVENTION

In view of this, it is one object of the present invention to provide independent audio-to-video synchronization control architecture to reduce response delay of a media playback device when the user switches channels or programs. In embodiments of the present invention, dedicated playback processing modules are established individually for different media sources (i.e., channels, programs or audiovisual contents), wherein each playback processing module has timing information that is independent from that of other playback processing modules. Under such architecture, each playback processing module can continue performing synchronization of audio content and video content based on independent timing information in the background. In this way, control of the audio-to-video synchronization on the media playback device would have better efficiency and occupy smaller hardware resources.

According to one embodiment, a media playback device is provided. The media playback device comprises one or more playback processing modules. The one or more playback processing modules respectively correspond to one or more media sources. At least one of the one or more playback processing modules comprises an audio and video control sub-module. The audio and video control sub-module is configured to provide and update timing information and control timing synchronization of the at least one playback processing module when processing a plurality of audio data units and a plurality of video data units according to the timing information.

According to one embodiment, a media playback method is provided. The media playback method comprises: establishing one or more playback processing modules respectively corresponding to one or more media sources; utilizing an audio and video control sub-module of at least one of the one or more playback processing modules to provide and update timing information; and controlling timing synchronization of the at least one playback processing module when processing a plurality of audio data units and a plurality of video data units according to the timing information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a media playback device according to one embodiment of the present invention.

FIG. 2A illustrates a schematic diagram of a source processing module according to one embodiment of the present invention.

FIG. 2B illustrates a schematic diagram of an implementation of the locking device 106A, the buffer device 107A and the demultiplexing device 108A in the source processing module.

FIG. 2C illustrates a schematic diagram of an implementation of the locking device 106B, the buffer device 107B and the demultiplexing device 108B in the source processing module.

FIG. 3 illustrates an operation flow and architecture of a playback processing module according to one embodiment of the present invention.

FIG. 4 illustrates a flow chart of a media playback method according to one embodiment of the present invention.

FIG. 5 illustrates a schematic diagram of hardware architecture of a media playback device according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

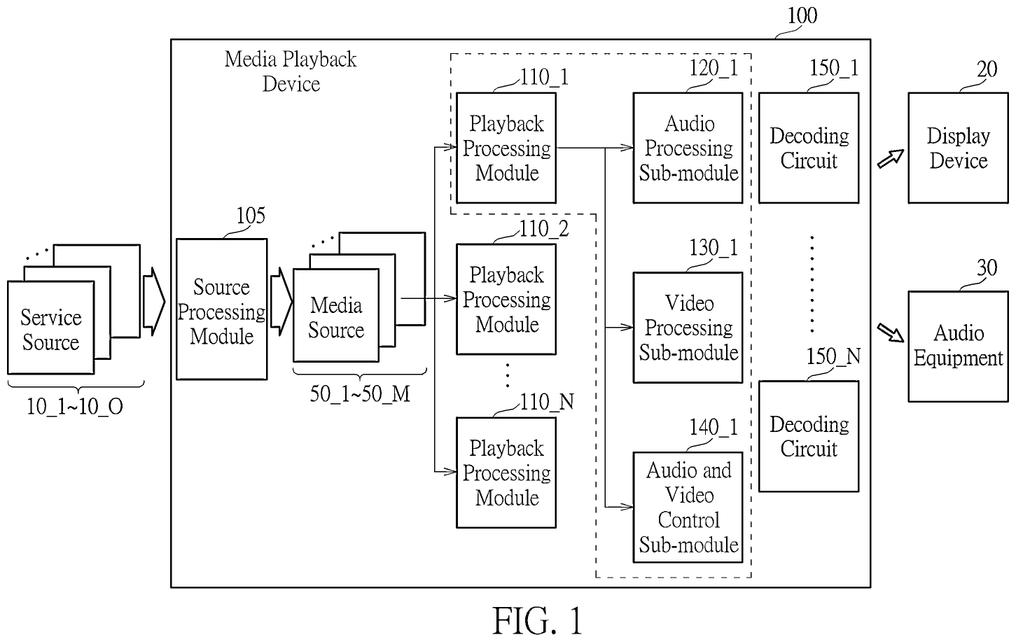

FIG. 1 is a schematic diagram of a media playback device according to one embodiment of the present invention. As shown in the figure, a media playback device 100 is configured to receive data streams from service sources 10_1-10_O and accordingly perform media playback. For example, the media playback device 100 may receive audiovisual contents transmitted in a format of MPEG-2 transport stream (MPEG-2 TS) from the service sources 10_1-10_O. According to various embodiments of the present invention, the service sources 10_1-10_O can transmit audiovisual contents to the media playback device 100 through one or more signal transmission methods. Furthermore, the data streams may be transmitted from the service sources 10_1-10_O to the media playback 100 in wired or wireless manners through one or more intermediate transmission devices. The service sources 10_1-10_O may include one or more of digital video broadcasting services, Internet protocol television services, and satellite television services. The media playback device 100 can output video/audio signals to a display device 20 and/or audio equipment 30 in wired or wireless manners through specific video/audio transmission interfaces, such as High Definition Multimedia Interface (HDMI) or DisplayPort (DP), so that audiovisual contents can be reproduced through the display device 20 and/or the audio equipment 30.

The media playback device 100 includes a source processing module 105. The source processing module 105 is configured to retrieve channels, programs or various audiovisual contents from the data streams transmitted by the service sources 10_1-10_O, thereby generating media sources 50_1-50_M. When the user intends to watch a specific channel, a specific program or a specific audiovisual content, the media playback device 100 would retrieve relevant data of multiple associated channels, multiple associated programs or multiple associated audiovisual contents from the media sources 50_1-50_M, thereby achieving fast channel change (FCC). Specifically, the source processing module 105 could lock related frequency points (if the media sources 50_1-50_M are channels, programs or audiovisual contents provided by the digital video broadcasting services or the satellite television services), or makes requests to servers (if the media sources 50_1-50_M are channels, programs or audiovisual contents provided by Internet protocol television services). In one embodiment, the data streams provided by the service sources 10_1-10_O may comprise video contents compressed by video coding standards based on moving picture experts group (MPEG), advanced video coding (AVC), high efficiency video coding (HEVC) or AOMedia Video 1 (AV1) standard. Furthermore, the data streams provided by the service sources 10_1-10_O may also comprise audio contents compressed by audio coding standards based on advanced codec 3 (AC-3), MPEG-1 audio layer III or MPEG-2 audio layer III (i.e., MP3), advanced audio coding (AAC), MPEG or other audio coding standards. It should be noted that the specific video/audio coding standards adopted for the audio/video contents in the data stream is not a limitation of the present invention. Depending on different design requirements, different video/audio coding standards may be applied.

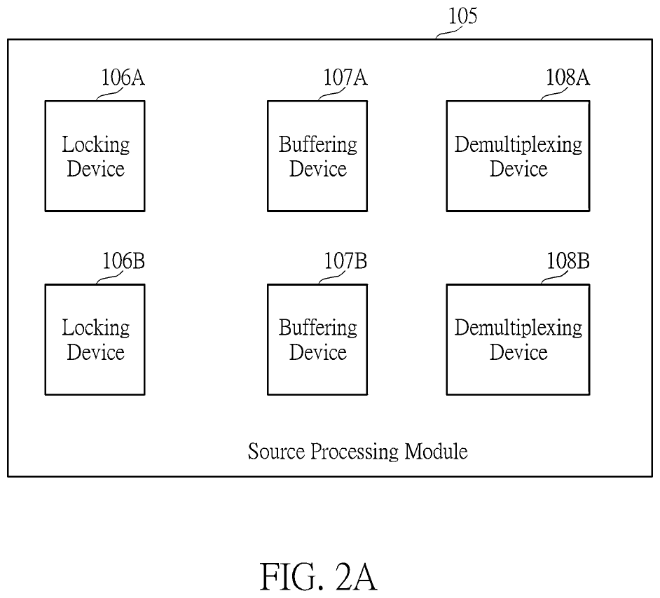

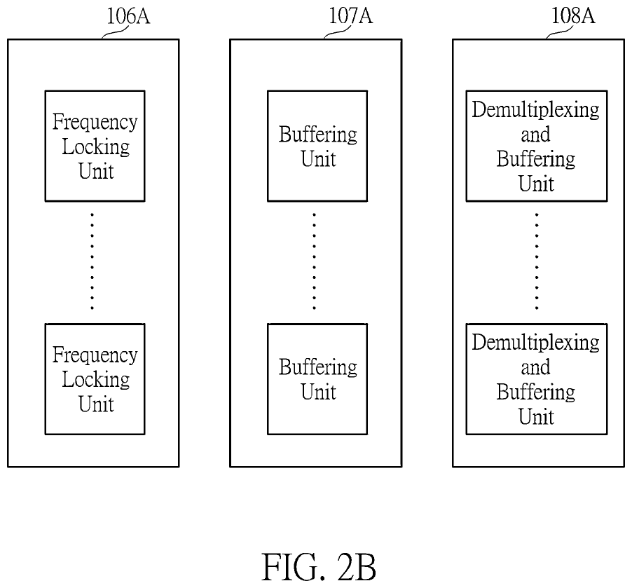

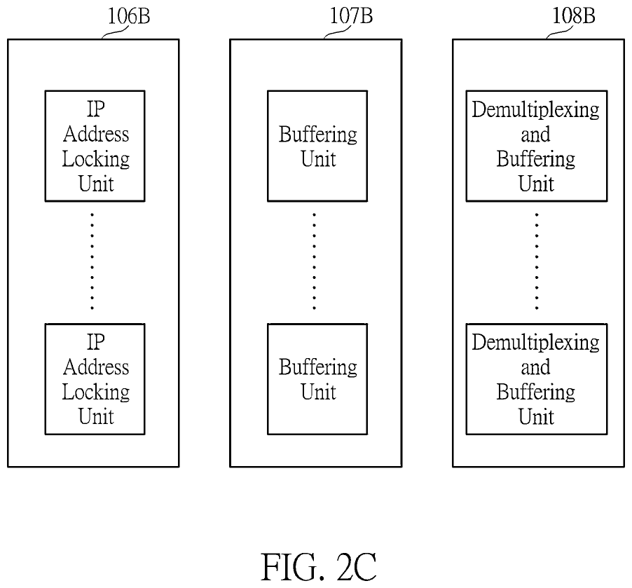

The media playback device 100 includes the source processing module 105 and one or more playback processing modules 110_1-110_N. The source processing module 105 is configured to generate different types of the media sources 50_1-50_M. Please refer to an exemplary schematic diagram of the source processing module 105 shown in FIG. 2A. As illustrated, the source processing module 105 includes locking devices 106A and 106B, buffering devices 107A and 107B, and demultiplexing devices 108A and 108B. The source processing module 105 can obtain data according to different service types that the media sources 50_1-50_M belong to (i.e., digital video broadcasting services, Internet protocol television services and satellite television services). FIG. 2B illustrates an exemplary schematic diagram of an implementation of the locking device 106A, the buffering device 107A and the demultiplexing device 108A. The locking device 106A includes a plurality of frequency locking units, the buffering device 107A includes a plurality of buffering units, and the demultiplexing device 108A includes a plurality of demultiplexing and buffering units. The frequency locking units are configured to respectively lock multiple frequency points of a digital video broadcast signal or a satellite television signal. In one embodiment, the media playback device 100 configures frequency locking points individually for the frequency locking units within the locking device 106A based on a FCC algorithm, and then retrieves data streams corresponding to one or more channels from the digital video broadcasting services or the satellite television services. In addition, although not shown in the figure, the locking device 106A may also include demodulators and analog-to-digital converters to perform demodulation and analog-to-digital conversion on a locked signal to output data at different frequency points. The buffering units of the buffering device 107A are configured to buffer data respectively retrieved by the frequency locking units of the locking device 106A. In some embodiments, the buffering units of the buffering device 107A can discard data units that do not belong to specific types. For example, the data units that are not associated with the audiovisual content or the data units corresponding to information types of emergency broadcast, system information, and/or electronic program guide (EPG) may be discarded. This can be achieved by recognizing packet identifier (PID) in the data units. Furthermore, the demultiplexing and buffering units of the demultiplexing device 108A are configured to perform demultiplexing, descrambling and buffering on the data buffered in the buffering units of the buffering device 107A. Thus, the media sources 50_1-50_M corresponding to audio/video data of specific digital video broadcast channels and/or specific satellite television channels can be obtained from the demultiplexing and buffering units of the demultiplexing device 108A for subsequent processing by the playback processing modules 110_1-110_N.

FIG. 2C illustrates specific schematic diagram of the locking device 106B, the buffering device 107B and the demultiplexing device 108B. The locking device 106B comprises multiple Internet protocol (IP) address locking units, the buffering device 107B comprises multiple buffering units, and the demultiplexing device 108B comprises multiple demultiplexing and buffering units. The IP address locking units are configured to lock multiple IP addresses associated with Internet protocol television services. Additionally, the locking device 106B may also include other circuit components such as demodulators and analog-to-digital converters, performing demodulation and analog-to-digital conversion on signals, so as to output data associated with different IP addresses. In one embodiment, the media playback device 100, based on a FCC algorithm, configures IP locking for individual IP address locking units within the locking device 106B, thereby retrieving data associated with one or more channels from the IPTV services. Furthermore, the buffering units of the buffering device 107B are configured to buffer the data retrieved by the IP address locking units of the locking device 106B. The demultiplexing and buffering units of the demultiplexing device 108B are configured to perform demultiplexing, descrambling, and buffering on the data buffered by the buffering units of the buffering device 107B. Thus, the media sources 50_1-50_M corresponding to audio/video data of specific IPTV channels can be obtained from the demultiplexing and buffering units of the demultiplexing device 108B, for subsequent processing by the playback processing modules 110_1-110_N.

According to user requirements, the media playback device 100 establishes the playback processing modules 110_1-110_N to process and reproduce audio contents and video contents provided by the media sources 50_1-50_M. In one embodiment, the media playback device 100 establishes the playback processing modules 110_1-110_N based on the number of decoding circuits 150_1-150_N. Each of the playback processing modules 110_1-110_N is assigned to a corresponding one of the media sources 50_1-50_M. When a playback operation performed by the user selects a specific media source from the media sources 50_1-50_M (e.g., choosing a channel, a program, or an audiovisual content), a corresponding one of the media sources 50_1-50_M is set to a foreground state, while others are set to a background state. The playback processing modules 110_1-110_N will reproduce the audio content and the video content of the media source that is set to the foreground state, allowing it to be played on the display device 20 and/or the audio equipment 30.

It is noteworthy that, in some embodiments of the present invention, multiple ones of the media sources 50_1-50_M may be set to the foreground state simultaneously. This is intended to implement specific functions of the media playback device 100, such as a picture-in-picture (PIP) function or a multi-program/channel preview function. In some embodiments, it is also possible to set the audio contents and the video contents of the media sources 50_1-50_M to the foreground state and the background state independently. For instance, over a period of time, the audio content of a media source 50_1 could be set to the background state, while its video content is set to the foreground state. For example, when the PIP function is enabled, the video contents of multiple media sources may all be set to the foreground state, but the audio content of only one media source is set to the foreground state, with the audio contents of the other media sources being set to the background state.

On the other hand, since the number of the playback processing modules 110_1-110_N is related to the number of the decoding circuits 150_1-150_N, the number of the playback processing modules 110_1-110_N might be smaller than the number of the media sources 50_1-50_M. Therefore, the playback processing modules 110_1-110_N may only correspond to a portion of the media sources 50_1-50_M. The media sources that the playback processing modules 110_1-110_N correspond to may change based on a channel, a program, or an audiovisual content currently being watched by the user, or other user operations. For example, the media source that the playback processing module 110_1 corresponds to could be a channel, a program, or an audiovisual content currently being watched by the user, while the media sources that the playback processing modules 110_2-110_N correspond to could be various channels, programs, or audiovisual contents that the user may watch later. These channels or programs that the user may watch later could be determined through a predictive algorithm or based on stored user preference settings. In other words, when the user playback operation switches the currently watched channel, program, or audiovisual content, the media sources that the playback processing modules 110_1-110_N correspond to may thus change.

For programs or channels provided by the media sources 50_1-50_M, the corresponding playback processing modules 110_1-110_N respectively establish audio processing sub-modules 120_1-120_N (only the audio processing sub-module 120_1 is shown), video processing sub-modules 130_1-130_N (only the video processing sub-module 130_1 is shown), and audio and video control sub-modules 140_1-140_N (only the audio and video control sub-module 140_1 is shown). The source processing module 105 transmits audio data units and video data units corresponding to the media sources 50_1-50_N of the media sources 50_1-50_M to the playback processing modules 110_1-110_N, respectively.

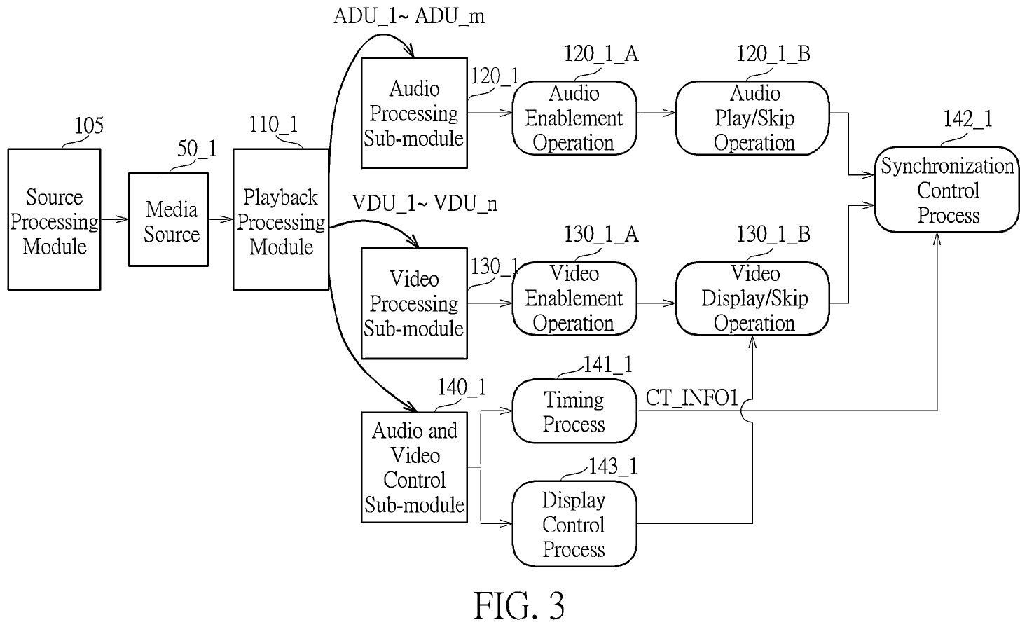

In one embodiment, the playback processing module 110_1 is configured to process audio data and video data of the media source 50_1. Please refer further to FIG. 3. As illustrated, the audio processing sub-module 120_1 receives audio data units ADU_1-ADU_m corresponding to the media source 50_1 and performs an audio enablement operation 120_1_A, thereby enabling processing of the audio data units ADU_1-ADU_m. In one embodiment, the audio data units ADU_1-ADU_m could be unit data of the audio content, for example, audio access units (representing encoded audio frames) as defined by MPEG2-TS standard. Specifically, the audio enablement operation 120_1_A comprises buffering the audio data units ADU_1-ADU_m (which can be stored in a buffer configured in a memory (not shown) of the media playback device 100) and setting parameters for audio decoding of a decoding circuit 150_1 according to a format of the audio data units ADU_1-ADU_m. Moreover, the audio processing sub-module 120_1, based on whether the audio content of the media source 50_1 is set to the foreground state or the background state, executes an audio play/skip operation 120_1_B_to perform audio decoding on the audio data units ADU_1-ADU_m or skip the audio decoding. When it is determined to perform the audio decoding on the audio data units ADU_1-ADU_m (i.e., the audio content of the media source 50_1 is set to the foreground state), the audio processing sub-module 120_1 enables the decoding circuit 150_1 to perform the audio decoding and outputs the decoded audio content. Additionally, during parsing of the audio data units ADU_1-ADU_m, the audio processing sub-module 120_1 records and preserves time information (e.g., presentation timestamps) carried by the audio data units ADU_1-ADU_m. On the other hand, when it is determined to skip the audio decoding on the audio data units ADU_1-ADU_m (i.e., the audio content of the media source 50_1 is set to the background state), only the presentation timestamps are obtained through the parsing of the audio data units ADU_1-ADU_m. Please note that, during the audio play/skip operation 120_1_B, whether choosing to perform or skip the audio decoding, the audio processing sub-module 120_1 would obtain the presentation timestamps corresponding to the audio data units ADU_1-ADU_m by parsing the audio data units ADU_1-ADU_m. In an embodiment where the audio decoding is skipped, after obtaining the presentation timestamps, the audio processing sub-module 120_1 discards the parsed audio data units ADU_1-ADU_m. Such operation effectively reduces the demand on the buffer memory (not shown) of the media playback device 100. Please note that, although the above contents only describe and elaborate operations of the audio processing sub-module 120_1, these contents are also applicable to the audio processing sub-modules 120_2-120_N not shown in the figure.

On the other hand, the video processing sub-module 130_1 receives video data units VDU_1-VDU_n corresponding to the media source 50_1 and performs a video enablement operation 130_1_A, thereby enabling processing of the video data units VDU_1-VDU_n. In one embodiment, the video data units VDU_1-VDU_n could be unit data of the video content, such as video access units (representing encoded picture data and subsequent related data) as defined by MPEG2-TS standard. The video enablement operation 130_1_A comprises buffering the video data units VDU_1-VDU_n (which can be stored in a buffer configured in a memory (not shown) of the media playback device 100) and setting parameters for video decoding of the decoding circuit 150_1 according to a format of video data units VDU_1-VDU_n. Moreover, based on whether the video content of the media source 50_1 processed by the video processing sub-module 130_1 is set to the foreground state or the background state, a video display/skip operation 130_1_B is executed to perform video decoding on the video data units VDU_1-VDU_n or skip the video decoding. When it is determined to perform the video decoding on the video data units VDU_1-VDU_n (i.e., the video content of the media source 50_1 is set to the foreground state), the video processing sub-module 130_1 enables the decoding circuit 150_1 to perform the video decoding and outputs the decoded video content. Additionally, the video processing sub-module 130_1 records and preserves the presentation timestamps carried by the video data units VDU_1-VDU_n during parsing of the video data units VDU_1-VDU_n. On the other hand, when it is determined to skip the video decoding on the video data units VDU_1-VDU_n (i.e., the video content of the media source 50_1 is set to the background state), only the presentation timestamps are obtained through the parsing of the video data units VDU_1-VDU_n. Please note that, during the video display/skip operation 130_1_B, whether choosing to perform or skip the video decoding, the video processing sub-module 130_1 would obtain the presentation timestamps corresponding to the video data units VDU_1-VDU_n by parsing the video data units VDU_1-VDU_n. In an embodiment where the video decoding is skipped, the video processing sub-module 130_1 discards the parsed video data units VDU_1-VDU_n after obtaining the presentation timestamps, thereby reducing the demand on the buffer memory of the media playback device 100. Please note that, although the above contents only describe and elaborate operations of the video processing sub-module 130_1, these contents are also applicable to the video processing sub-modules 130_2-130_N not shown in the figure.

In one embodiment, the audio and video control sub-module 140_1 includes a timing process 141_1, a synchronization control process 142_1, and a display control process 143_1. Please note that the following explanations also apply to timing processes, synchronization control processes, and display control processes included within the audio and video control sub-modules 140_2-140_N not shown in the figure. The timing process 141_1 is configured to perform a timing operation to provide and update timing information CT_INFO1. In one embodiment, the timing process 141_1 can perform the timing operation to provide and update the timing information CT_INFO1 based on a reference clock generated by an oscillating circuit (not shown) within the media playback device 100. When the playback processing module 110_1 begins receiving and processing the audio data units ADU_1-ADU_m and the video data units VDU_1-VDU_n, the timing process 141_1 starts accumulating/counting time based on the reference clock to provide and update the timing information CT_INFO1 for utilization by the synchronization control process 142_1. In one embodiment, if the video content of the media source 50_1 is a still image, the timing program 141_1 can pause the timing, stopping the update of the timing information CT_INFO1, since there is no need for audio-to-video synchronization at that moment.

The synchronization control process 142_1 maintains the synchronization of audio processing and video processing within the playback processing module 110_1 through the timing information CT_INFO1. More specifically, both the audio data units ADU_1-ADU_m and the video data units VDU_1-VDU_n have their respective presentation timestamps, for example, presentation timestamps APTS_1-APTS_m corresponding to the audio data units ADU_1-ADU_m and presentation timestamps VPTS_1-VPTS_n corresponding to the video data units VDU_1-VDU_n. The synchronization control process 142_1 can perform synchronization control based on the timing information CT_INFO1, the presentation timestamps APTS_1-APTS_m, and the presentation timestamps VPTS_1-VPTS_n. In a condition where audio and video is out of synchronization, the synchronization control process 142_1 can shift the timing of the processing of the audio data units ADU_1-ADU_m and the video data units VDU_1-VDU_n within the playback processing module 110_1 to achieve temporal alignment. This ensures that various operations (such as decoding/output) on the audio data units ADU_1-ADU_m and the video data units VDU_1-VDU_n within the playback processing module 110_1 are aligned in time.

In the present invention, the synchronization control processes within different the playback processing modules 110_1-110_N may provide different timing information, for example, timing information CT_INFO1 provided by the synchronization control process 143_1 of the playback processing module 110_1 may differ from timing information CT_INFO2 provided by a synchronization control process 143_2 of the playback processing module 110_2. This is because synchronization control processes 143_1 and 143_2 could update their respective timing information based on the processing status of different media sources by the playback processing modules 110_1 and 110_2, respectively. Consequently, this achieves independent audio-to-video synchronization control for different channels. Such architecture with multi-channel independent audio-to-video synchronization control offers better efficiency and consumes less hardware resources compared to the architecture with audio-to-video synchronization control that shares timing information.

The display control process 143_1 could control the video display/skip operation 130_1_B of the video processing sub-module 130_1 based on the foreground/background state setting of the video content of the media source 50_1, thereby determining whether to enable the video decoding or to skip the video decoding. It is worth mentioning that the audio play/skip operation 120_1_B of the audio processing sub-module 120_1 can be controlled either by the display control process 143_1, referencing the foreground/background state setting of the video content of the media source 50_1, or by the audio processing sub-module 120_1, referencing the foreground/background state setting of the audio content of the media source 50_1. This is because, in certain situations, the foreground/background states of the audio content and the video content may not consistent (when the PIP function of the media playback device 100 being enabled). Hence, the audio play/skip operation 120_1_B for enablement of the audio decoding and the video display/skip operation 130_1_B for enablement of the video decoding may need to be controlled separately.

When the user playback operation switches from the originally watched channel, program, or audiovisual content to another channel, program, or audiovisual content, the media source that at least one of the playback processing modules 110_1-110_N corresponds to would change, and the operational state of the playback processing modules 110_1-110_N would also need to be adjusted accordingly. Taking the playback processing module 110_1 as an example, during content switching, the media source that the playback processing module 110_1 corresponds to might switch from the media source 50_1 to the media source 50_6. At this time, the audio and video control sub-module 140_1 would clear the current timing information CT_INFO1 of the timing process 141_1, since the current timing information CT_INFO1, which is applicable to the channel, program, or audiovisual content that the media source 50_1 corresponds to, is not applicable to the channel, program, or audiovisual content that the media source 50_6 corresponds to. Additionally, the audio processing sub-module 120_1 and the video processing sub-module 130_1 can choose to retain or reset current decoding settings. Specifically, when the channels, programs, or audiovisual contents that the media source 50_1 and the media source 50_6 correspond to have the same video/audio encoding format, the audio processing sub-module 120_1 and the video processing sub-module 130_1 may choose to retain the current decoding settings. However, when the channels, programs, or audiovisual contents that the media source 50_1 and the media source 50_6 correspond to have different video/audio encoding formats, the audio processing sub-module 120_1 and the video processing sub-module 130_1 would reset the current decoding settings.

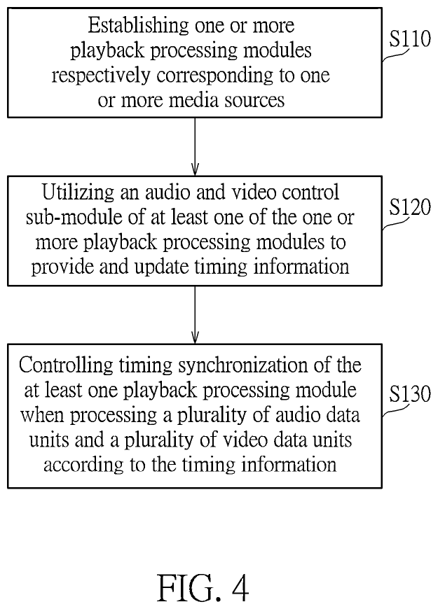

Based on the above embodiments, FIG. 4 illustrates a simplified flow of a media playback method for use in a media playback device. As shown in the figure, the flow comprises the following steps:
Step S110: establishing one or more playback processing modules respectively corresponding to one or more media sources;
Step S120: utilizing an audio and video control sub-module of at least one of the one or more playback processing modules to provide and update timing information; and
Step S130: controlling timing synchronization of the at least one playback processing module when processing a plurality of audio data units and a plurality of video data units according to the timing information.

Since the principles and specific details of the aforementioned steps have already been thoroughly explained through previous embodiments, they will not be repeated here. It should be noted that the above flow can be enhanced by adding additional steps or by making appropriate modifications and adjustments, to better realize the processing and synchronization of video and audio data, thereby achieving a superior user experience in media playback.

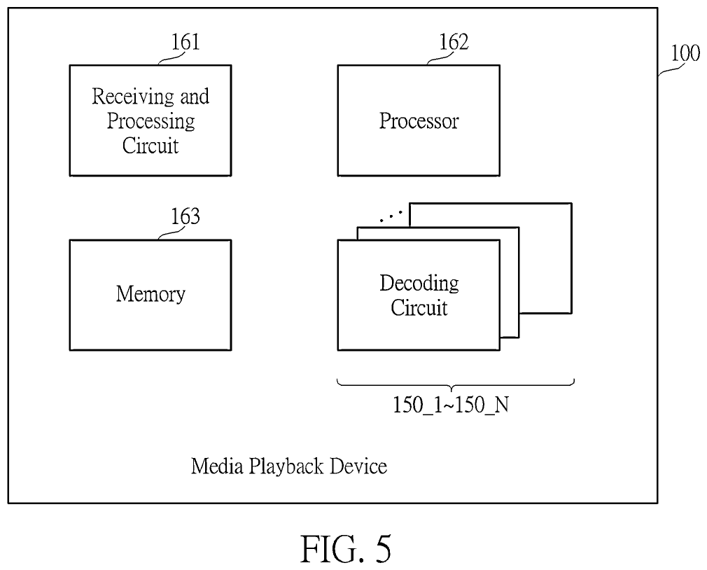

FIG. 5 illustrates a schematic diagram of hardware architecture of a media playback device according to one embodiment of the present invention. As shown in the figure, the media playback device 100 may include the following hardware circuit components: a receiving and processing circuit 161, a processor 162, a memory 163, and the decoding circuits 150_1-150_N. The receiving and processing circuit 161 is configured to perform communication with the service sources 10_1-10_O to obtain the media sources 50_1-50_N. The receiving and processing circuit 161 may include analog and/or digital circuits capable of handling various communication protocols (such as demodulation, descrambling, demultiplexing circuits, etc.). In one embodiment, functional blocks within the aforementioned source processing module 105 can be implemented by the receiving and processing circuit 161 and processor 162 executing specific program codes, while the buffering units within the source processing module 105 can be realized by configuring buffering areas within the memory 163. Furthermore, the playback processing modules 110_1-110_N, the audio processing sub-modules 120_1-120_N, the video processing sub-modules 130_1-130_N, the audio and video control sub-modules 140_1-140_N, the timing processes 141_1-141_N, the synchronization control processes 142_1-142_N, and the display control processes 143_1-143_N mentioned in the aforementioned embodiment can be realized by the processor 162 executing specific program codes and/or by configuring buffering areas within the memory 163.

In summary, the media playback device and method of the present invention can effectively reduce the response delay when the user switches channels, programs, or audiovisual contents. The present invention establishes multiple playback processing modules that maintain audio-to-video synchronization of the audio content and the video content of corresponding media sources in the background state. Additionally, the playback processing modules operating in the background state could maintain the audio-to-video synchronization merely by recording presentation timestamps, thus minimizing the occupation of hardware resources. Moreover, since each playback processing module possesses timing information independent of other playback processing modules, rather than sharing a set of timing information, this significantly enhances the efficiency of synchronization control.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks. Additionally, as used in the specification, “A and/or B” and “at least one of A and B” refer to any combination of one or more of listed associated items A and B, for example, A, B or a combination of A and B.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A media playback device, comprising:
one or more playback processing modules, respectively corresponding to one or more media sources; wherein at least one of the one or more playback processing modules comprises:
an audio and video control sub-module, configured to provide and update timing information and control timing synchronization of the at least one playback processing module when processing a plurality of audio data units and a plurality of video data units according to the timing information.

2. The media playback device of claim 1, wherein the at least one playback processing module further comprises:
an audio processing sub-module, configured to receive and process the plurality of audio data units that are provided by a specific media source of the one or more media sources, and selectively enabling audio decoding; and
a video processing sub-module, configured to receive and process the plurality of video data units that are provided by the specific media source, and selectively enabling video decoding.

3. The media playback device of claim 2, wherein the at least one playback processing module further comprises:
a decoding circuit, configured to be controlled by the audio processing sub-module and the video processing sub-module to perform at least one of the audio decoding and the video decoding, wherein when the audio processing sub-module enables the audio decoding, the decoding circuit is configured to perform the audio decoding on the plurality of audio data units; and when the video processing sub-module enables the video decoding, the decoding circuit is configured to perform the video decoding on the plurality of video data units.

4. The media playback device of claim 3, wherein the audio processing sub-module is configured to record presentation timestamps corresponding to the plurality of audio data units; and the video processing sub-module is configured to record presentation timestamps corresponding to the plurality of video data units.

5. The media playback device of claim 4, wherein when the audio processing sub-module does not enable the audio decoding, the audio processing sub-module records the presentation timestamps respectively corresponding to the plurality of audio data units, and then discards the plurality of audio data units; when the video processing sub-module does not enable the video decoding, the video processing sub-module records the presentation timestamps respectively corresponding to the plurality of video data units, and then discards the plurality of video data units.

6. The media playback device of claim 4, wherein the audio and video control sub-module comprises:
a timing process, configured to provide and update the timing information based on a reference clock generated by an oscillator circuit of the media playback device; and
a synchronization control process, configured to control timing synchronization of the at least one playback processing module when processing the plurality of audio data units and the plurality of video data units according to the timing information, the presentation timestamps respectively corresponding to the plurality of audio data units, and the presentation timestamps respectively corresponding to the plurality of video data units.

7. The media playback device of claim 6, wherein the one or more playback processing modules include a first playback processing module and a second playback processing module; an audio and video control sub-module of the first playback processing module includes a first timing process, and an audio and video control sub-module of the second playback processing module includes a second timing process, wherein the first timing process and the second timing process respectively provide and update timing information that is independent from each other, thereby to control the first playback processing module and the second playback processing module.

8. The media playback device of claim 6, wherein when the media source that the at least one playback processing module corresponds to is switched from a first specific media source to a second specific media source based on a user operation, the timing process resets the timing information, and the audio processing sub-module and the video processing sub-module respectively retain settings of the audio decoding and the video decoding of the decoding circuit.

9. The media playback device of claim 6, wherein the audio and video control sub-module further includes:
a display control process, configured to control the video processing sub-module according to a user operation, such that the video processing sub-module selectively enables the video decoding;
wherein an enablement state of the video decoding controlled by the video processing sub-module can be different from an enablement state of the audio decoding controlled by the audio processing sub-module.

10. A media playback method, comprising:
establishing one or more playback processing modules respectively corresponding to one or more media sources;
utilizing an audio and video control sub-module of at least one of the one or more playback processing modules to provide and update timing information; and
controlling timing synchronization of the at least one playback processing module when processing a plurality of audio data units and a plurality of video data units according to the timing information.

11. The media playback method of claim 10, further comprising:
utilizing an audio processing sub-module of the audio and video control sub-module to receive and process the plurality of audio data units that are provided by a specific media source of the one or more media sources, and selectively enable audio decoding; and
utilizing a video processing sub-module of the audio and video control sub-module to receive and process the plurality of video data units that are provided by the specific media source, and selectively enable video decoding.

12. The media playback method of claim 11, further comprising:
utilizing a decoding circuit to perform the audio decoding when the audio processing sub-module enables the audio decoding, or to perform the video decoding when the video processing sub-module enables the video decoding.

13. The media playback method of claim 12, further comprising:
utilizing the audio processing sub-module to record presentation timestamps corresponding to the plurality of audio data units; and
utilizing the video processing sub-module to record presentation timestamps corresponding to the plurality of video data units.

14. The media playback method of claim 13, further comprising:
when not enabling the audio decoding, utilizing the audio processing sub-module to record the presentation timestamps respectively corresponding to the plurality of audio data units, and then discard the plurality of audio data units; and
when not enabling the video decoding, utilizing the video processing sub-module to record the presentation timestamps respectively corresponding to the plurality of video data units, and then discard the plurality of video data units.

15. The media playback method of claim 13, wherein the step of controlling timing synchronization of the at least one playback processing module when processing the plurality of audio data units and the plurality of video data units comprises:
provide and update the timing information based on a reference clock generated by an oscillator circuit; and
controlling timing synchronization of the at least one playback processing module when processing the plurality of audio data units and the plurality of video data units according to the timing information, the presentation timestamps respectively corresponding to the plurality of audio data units, and the presentation timestamps respectively corresponding to the plurality of video data units.

16. The media playback method of claim 15, wherein the one or more playback processing modules include a first playback processing module and a second playback processing module, and the media playback method further comprises:
respectively providing and updating timing information that is independent from each other, thereby to control the first playback processing module and the second playback processing module.

17. The media playback method of claim 15, further comprising:
switching the media source that the at least one playback processing module corresponds to from a first specific media source to a second specific media source based on a user operation; and
resetting the timing information, and retaining settings of the audio decoding and the video decoding of the decoding circuit.

18. The media playback method of claim 15, further comprising:
controlling the video processing sub-module according to a user operation to allow the video processing sub-module to selectively enable the video decoding, wherein an enablement state of the video decoding controlled by the video processing sub-module can be different from an enablement state of the audio decoding controlled by the audio processing sub-module.
